(19) United States
(12) Patent Application Publication
(10) Pub. No.: US 2019/0084255 A1
(43) Pub. Date: Mar. 21, 2019

(54) METHOD OF PRODUCING LENS UNIT AND METHOD OF PRODUCING IMAGING APPARATUS

(71) Applicant: OLYMPUS CORPORATION, Tokyo (JP)

(72) Inventors: Kazunari HANANO, Hachioji-shi (JP); Susumu TAKAHASHI, Iruma-shi (JP); Yasuhiro MIYAZAKI, Hachioji-shi (JP)

(73) Assignee: OLYMPUS CORPORATION, Tokyo (JP)

(21) Appl. No.: 16/173,650

(22) Filed: Oct. 29, 2018

Related U.S. Application Data
(63) Continuation of application No. PCT/JP2016/064040, filed on May 11, 2016.

(51) Int. Cl. B29D 11/00; B33Y 10/00; B33Y 80/00; G02B 7/02; G02B 5/00

(52) U.S. Cl. CPC B29D 11/00403; B33Y 10/00; B33Y 80/00; B29C 64/112; G02B 5/003; B29K 2995/0026; B29K 2995/0025; G02B 7/02

(57) ABSTRACT

A method of producing a lens unit includes forming a layer by switching between a transmissive material that allows transmission of light and a light-shielding material that shields light, and stacking formed layers to form a lens from the transmissive material and forma barrel that holds the lens from the light-shielding material.

### CROSS-REFERENCE TO RELATED APPLICATIONS

This application is a Continuation Application of PCT Application No. PCT/JP2016/064040, filed May 11, 2016, the entire contents of all of which are incorporated herein by reference.

### FIELD

Embodiments of the present invention relate to a method of producing a lens unit and a method of producing an imaging apparatus.

### BACKGROUND

A lens unit that forms an image by light on an image sensor includes a lens and a barrel that holds the lens. Generally, a lens is formed by grinding and polishing or molding glass or resin. A barrel includes a plurality of members formed by grinding and polishing, and/or molding metal or resin. A lens unit is configured in a manner so that the lens combined with the plurality of members of the barrel is housed in the barrel.

For example, Jpn. Pat. Appln. KOKAI Publication No. 2004-066773 discloses that a lens and a barrel are integrally formed by inserting the lens and molding the barrel on the outer periphery of the inserted lens.

However, this may cause variation in produced lens units due to errors in processing lenses and assembling errors in inserting lenses. Reduction of processing errors and assembling errors requires accuracy in processing and assembling, thereby causing a problem of an increase in cost.

### SUMMARY

An object of the present invention is to provide a method of producing a lens unit having small variation in optical performance at low cost, and a method of producing an imaging apparatus.

A method of producing a lens unit includes forming a layer by switching between a transmissive material that allows transmission of light and a light-shielding material that shields light, and stacking formed layers to form a lens from the transmissive material and forma barrel that holds the lens from the light-shielding material.

According to the present invention, it is possible to provide a method of producing a lens unit having small variation in optical performance at low cost, and a method of producing an imaging apparatus.

### BRIEF DESCRIPTION OF THE DRAWINGS

FIG. 1 is a view to explain an example of a 3D printer according to one embodiment.

FIG. 2 is a view to explain an example of a step of forming a part of a barrel of a lens unit according to one embodiment.

FIG. 3 is a view to explain an example of a step of forming a part of the barrel and a part of a lens of the lens unit according to one embodiment.

FIG. 4 is a view to explain an example of a step of forming an aperture according to one embodiment.

FIG. 5 is a view to explain an example of a step of forming a curved surface of the lens according to one embodiment.

FIG. 6 is a view to explain an example of a step of arranging an image sensor in the lens unit according to one embodiment.

FIG. 7 is a view to explain an example of a configuration of the image sensor according to one embodiment.

FIG. 8 is a view to explain an example of a step of forming a part of a barrel and a part of a lens of a lens unit according to another embodiment.

FIG. 9 is a view to explain an example of a step of forming a cover plate according to another embodiment.

FIG. 10 is a view to explain an example in which an image sensor according to another embodiment is arranged on a stage of a 3D printer.

FIG. 11 is a view to explain an example of a step of forming a compensation optical system on the cover plate according to another embodiment.

FIG. 12 is a view to explain an example of a step of forming a seal on a periphery of the cover plate according to another embodiment.

FIG. 13 is a view to explain an example of a step of forming an flare aperture according to another embodiment.

FIG. 14 is a view to explain an example of a step of forming the compensation optical system on a curved surface of the lens according to another embodiment.

FIG. 15 is a view to explain another example of the lens unit according to another embodiment.

FIG. 16 is a view to explain another example of the lens unit according to another embodiment.

### DETAILED DESCRIPTION

Hereinafter, a method of producing a lens unit and a method of producing an imaging apparatus will be described in detail.

In the present embodiment, a lens and a barrel of a lens unit for use in an imaging apparatus are integrally formed by a so-called 3D printer that produces a solid object based on three-dimensional data. Hereinafter, described as an example of a 3D printer is an ink-jet type 3D printer that forms a solid object by discharging liquid resin that is curable by light (for example, ultraviolet light) and curing this resin with ultraviolet light. However, a 3D printer is not limited to this ink-jet type. A 3D printer may adopt any modeling method.

In the present embodiment, a 3D printer forms a part corresponding to a barrel (light-shielding part) of a lens unit from a light-shielding resin material (light-shielding material), and forms a part corresponding to a lens (transparent part) of the lens unit from a light-transmitting resin material (transmissive material). Specifically, the light-shielding material is a resin material that absorbs more light of a target wavelength, which depends on the intended use of a lens unit, than the transmissive material. That is, the transmissive material is a resin material that absorbs less light of a target wavelength, depending on the intended use of a lens unit, than the light-shielding material.

In the present embodiment, three-dimensional data is data on a shape in a three-dimensional space having a width, a depth, and a height. Hereinafter, for example, a width direction is represented as an x-direction, a depth direction is represented as a y-direction, and a height direction is represented as a z-direction. In addition, the data on the shape includes information indicating the presence/absence of a dot, and information on a material. The information on the material indicates, for example, whether a material is a light-shielding material or a transmissive material. The three-dimensional data may be data obtained by converting data such as 3D-CAD data or 3D-CG data in accordance with the resolution of a 3D printer.

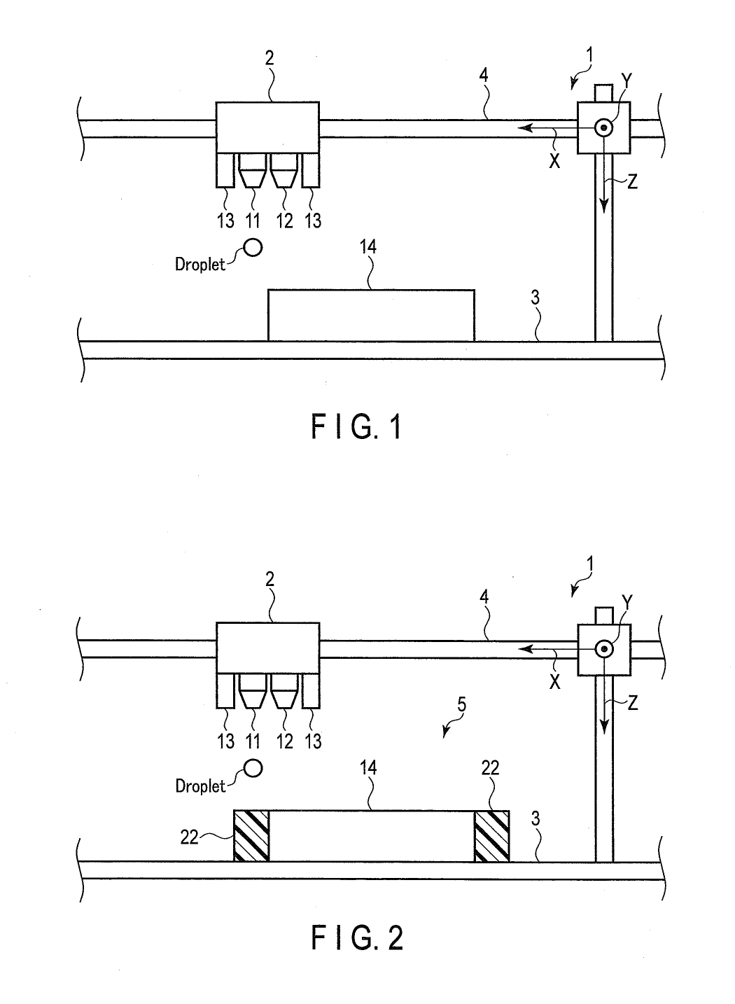

FIG. 1 is an explanatory drawing to explain an example of a 3D printer 1 according to one embodiment. The 3D printer 1 includes a print head 2, a stage 3, and a positioning mechanism 4.

The print head 2 discharges liquid resin as droplets. The print head 2 includes a first nozzle 11, a second nozzle 12, and an ultraviolet-rays lamp 13. The print head 2 includes a first ink room (not shown) filled with the light-shielding material, and a second ink room (not shown) filled with the transmissive material.

The first nozzle 11 discharges, as droplets, the light-shielding material within the first ink room.

The second nozzle 12 discharges, as droplets, the transmissive material within the second ink room.

The ultraviolet-rays lamp 13 irradiates droplets discharged from the first nozzle 11 and the second nozzle 12, with ultraviolet light so that the droplets cure to form a partial configuration (referred to as a resin structure) of a solid object. The ultraviolet-rays lamp 13 may be configured to output ultraviolet light when droplets are discharged from the first nozzle 11 or the second nozzle 12, or may be configured to constantly output ultraviolet light.

The stage 3 is a member that holds droplets discharged from the print head 2. The stage 3 includes a molding surface formed flushly.

The positioning mechanism 4 determines an impact position of droplets discharged from the print head 2 by moving the print head 2. For example, the positioning mechanism 4 adjusts an impact position of droplets within a surface parallel to the molding surface of the stage 3 by moving the print head 2 in the width direction (corresponding to the x-direction) parallel to the molding surface of the stage 3 and the depth direction (corresponding to the y-direction). The positioning mechanism 4 adjusts a distance between the molding surface of the stage 3 and the print head 2 by moving the print head 2 in the direction (corresponding to the z-direction) perpendicular to the molding surface of the stage 3.

The 3D printer 1 forms layers of the resin structure by moving the print head 2 in the x-direction and the y-direction by means of the positioning mechanism 4 while discharging droplets from the print head 2 to the stage 3. Specifically, the 3D printer 1 moves the print head 2 by the positioning mechanism 4 to a position corresponding to coordinates of three-dimensional data. According to data on shape of the aforementioned coordinates, the 3D printer 1 determines whether to discharge no droplets, discharge droplets from the first nozzle 11, or discharge droplets from the second nozzle 12. According to a result of this determination, the 3D printer 1 operates the print head 2. That is, the 3D printer 1 forms layer by switching droplets to be discharged, between the transmissive material and the light-shielding material, depending on the three-dimensional data. In this manner, the 3D printer 1 forms layer including at least one of a transparent part formed from the transmissive material and a light-shielding part formed from the light-shielding material. The 3D printer 1 forms resin layer while moving the print head 2 in the z-direction through the positioning mechanism 4, thereby forming a solid object with a laminated structure in which the aforementioned layers are stacked.

In order to form a resin structure in a position apart in the z-direction from the molding surface of the stage 3, a supporting member to support droplets is required. The supporting member may be a resin structure one layer below or may be any object placed on the molding surface of the stage 3. In the example shown in FIG. 1, a base member 14 as the supporting member is placed on the molding surface of the stage 3.

For example, the base member 14 forms a cylindrical shape having an upper surface and a bottom surface, and at least the bottom surface is formed flush. The base member 14 is placed on the stage 3 in a manner so that the bottom surface of the base member 14 faces the molding surface of the stage 3. The base member 14 is configured to have a given interval between the bottom surface and the upper surface. That is, the base member 14 has its upper surface arranged in a given height position above the molding surface of the stage 3. The upper surface of the base member 14 may be formed flush or may be formed as a curved surface.

### First Embodiment

Next, a specific method of producing a lens unit 5 according to the first embodiment will be described with reference to FIGS. 2 to 5. The example shown in each of FIGS. 2 to 5 produces the lens unit 5 in an axially symmetrical shape around the optical axis of the lens 21. Therefore, the lens unit 5 is produced by matching positions of the circular center of the base member 14 and the optical axis of the lens 21 of the lens unit 5. In the finished lens unit 5 while being pointed at a subject, a site close to the subject is referred to as a front end side, whereas a site close to an image is referred to as a rear end side. Described in the present embodiment is the example in which the lens unit 5 is produced by stacking the resin structures in order from the rear end side.

FIG. 2 is an explanatory drawing illustrating an example of a step of forming a part of the barrel 22 of the lens unit 5 from a resin material. The subsequent drawings illustrate the cross section of the formed resin structure when being cut at a surface including the optical axis of the lens 21.

The 3D printer 1 forms a barrel 22 on the stage 3, from the light-shielding material. For example, the 3D printer 1 stacks layers of a resin structure using the light-shielding material on the stage 3 along the outer periphery of the base material 14. The 3D printer 1 stacks layers of a resin structure up to at least the same height as the upper surface of the base member 14.

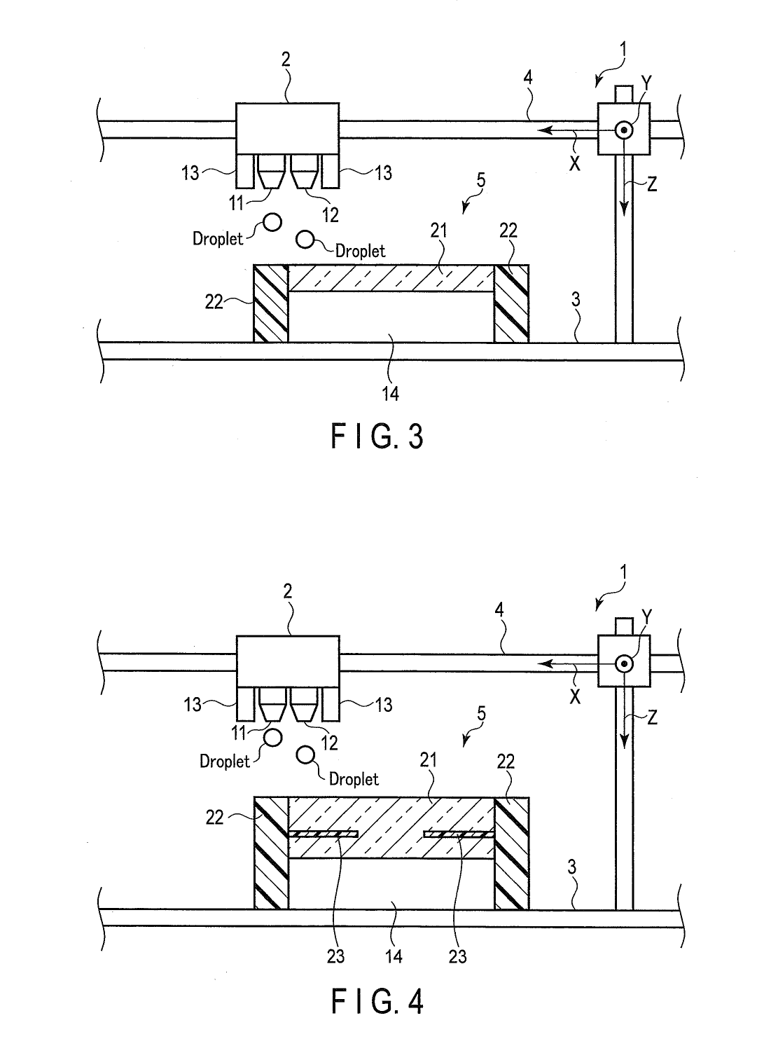

FIG. 3 is an explanatory drawing illustrating an example of a step of forming a part of the barrel 22 and a part of a lens 21 of the lens unit 5 from resin material.

The 3D printer 1 forms the lens 21 from the transmissive material on the upper surface of the base material 14, and further forms the barrel 22 from the light-shielding material. Specifically, while moving the print head 2, the 3D printer 1 discharges the light-shielding material from the first nozzle 11 when the print head 2 reaches a position on the stage 3 at which the barrel 22 is to be formed, and discharges the transmissive material from the second nozzle 12 when the print head 2 reaches a position on the stage 3 at which the lens 21 is to be formed.

FIG. 4 is an explanatory drawing illustrating an example of a step of forming an aperture 23.

The aperture 23 is a circular aperture that limits the amount of light passing through the lens 21. The 3D printer 1 forms the aperture 23 within the barrel 22, from the light-shielding material. For example, the 3D printer 1 forms the aperture 23 from the light-shielding material on the lens 21 formed from the transmissive material. For example, the 3D printer 1 forms the aperture 23 by forming an opening in a circular region with the optical axis of the lens 21 as the center, and forming the resin structure from the light-shielding material in the other region inside the barrel 22.

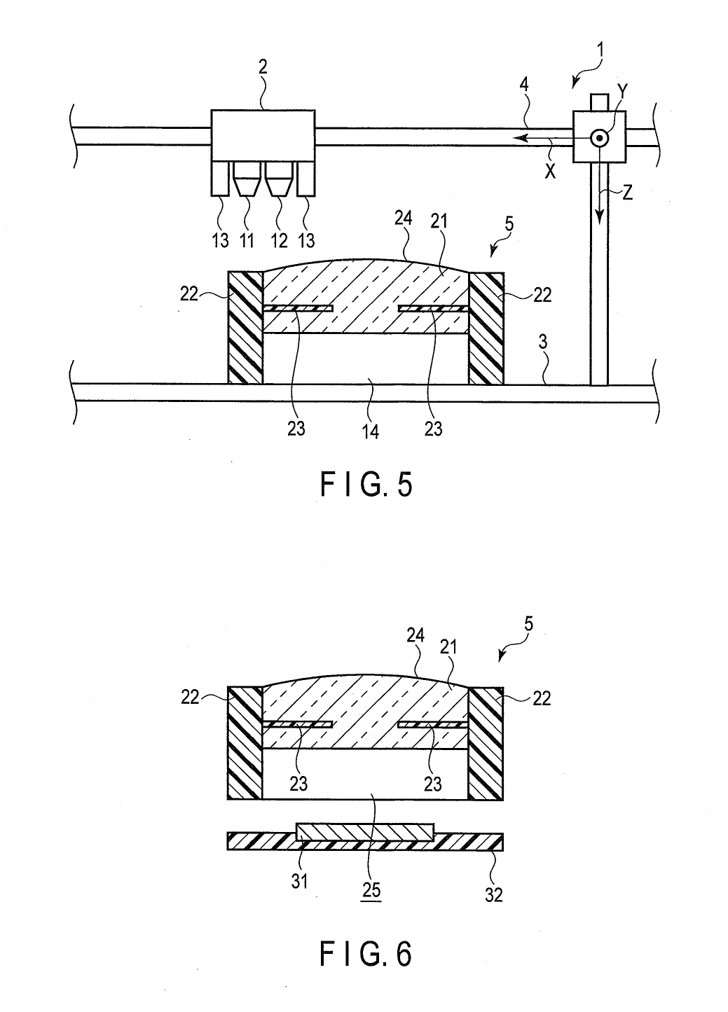

FIG. 5 is an explanatory drawing illustrating an example of a step of forming a curved surface 24 of the lens 21.

The 3D printer 1 forms the curved surface 24 from the transmissive material on the lens 21 formed from the transmissive material. That is, the 3D printer 1 sets a surface opposite to a surface facing the base member 14 of the lens 21 to the curved surface 24 with a given curvature.

The steps described above can produce the lens unit 5 in which the lens 21 formed from the transmissive material and the barrel that holds this lens 21 and is formed from the light-shielding material are integrally formed.

Described next is the method of producing an imaging apparatus 6 using the lens unit 5 produced through the above steps.

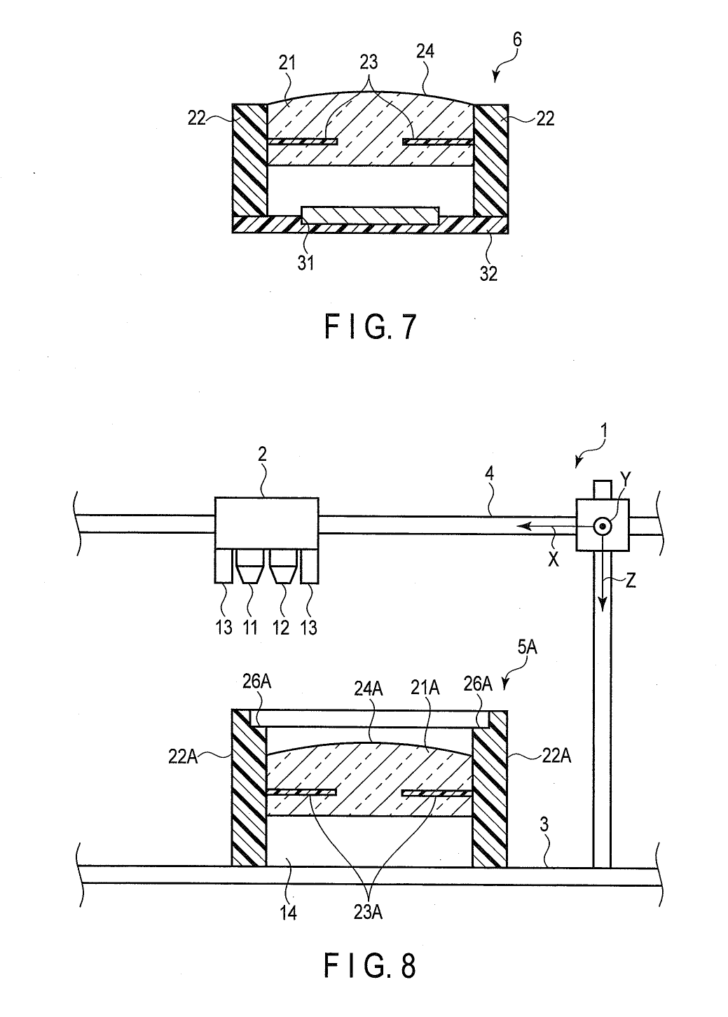

FIGS. 6 and 7 are explanatory drawings each illustrating an example of a step of arranging an image sensor 31 on the lens unit 5.

The lens unit 5 becomes available after it is separated from the stage 3 and the base member 14 is removed. Removal of the base member 14 brings to the lens unit 5 an opening 25 that is formed inside the barrel 22 in a rear end of the lens unit 5.

The image sensor 31 includes an imaging plane constituted by arranging a plurality of pixels which photoelectrically convert light and store charges. The image sensor 31 includes, for example, a Charge Coupled Devices (CCD) image sensor, a Complementary Metal Oxide Semiconductor (CMOS) image sensor, or another image sensor. The image sensor 31 is formed on a substrate 32. The substrate 32 is made of, for example, resin, and is formed into a shape similar to the opening 25 or formed larger than the opening 25.

As shown in FIG. 7, the substrate 32 on which the image sensor 31 is mounted is arranged in the opening 25 of the lens unit 5. For example, the substrate 32 is arranged in the opening 25 of the lens unit 5 by matching positions of the center of the imaging plane of the image sensor 31 and the optical axis of the lens 21 of the lens unit 5. In this manner, an image is formed on the imaging plane of the image sensor 31 by the lens 21 of the lens unit 5.

The steps described above can produce the imaging apparatus 6 including the lens unit 5 and the image sensor 31 that converts an image of a subject formed by the lens 21 of the lens unit 5 into an electrical signal (image signal).

Described in the above embodiment is that after the lens unit 5 is produced, the imaging apparatus 6 is produced by arranging the substrate 32 on which the image sensor 31 is mounted, in the opening 25 of the lens unit 5. However, the above embodiment is not limited to this configuration. The barrel 22 and the lens 21 may be formed by arranging, instead of the aforementioned base member, the substrate 32 on which the image sensor 31 is mounted, on the stage 3. That is, the image sensor 31 may be incorporated during the step of forming the barrel 22 and the lens 21.

According to the above embodiment, the 3D printer 1 forms the lens unit 5 by integrating the lens 21 formed from the transmissive material, with the barrel 22 holding this lens 21 and formed from the light-shielding material. This eliminates the necessity of, for example, positioning between the lens and the barrel, which is required to produce existing lens units. As a result, it is possible to reduce variation and costs of production in lens units.

According to the above embodiment, the 3D printer 1 forms the aperture 23 within the barrel 22 of the lens unit 5, from the resin structure made of the light-shielding material. This configuration eliminates limitations on the aperture 23 in terms of mounting method and installation location, thereby improving a degree of freedom in design of the lens unit 5.

### Second Embodiment

Next, a specific method of producing a lens unit 5A according to the second embodiment will be described with reference to FIGS. 8 to 12. The same structures as those in the first embodiment are assigned with the same reference numerals, and a detailed description of such structures are omitted. In the second embodiment, a resin structure similar to that of the lens unit 5 in FIG. 5 is formed through the same steps as those of the first embodiment shown in FIGS. 2 to 5.

FIG. 8 is an explanatory drawing illustrating an example of a step of forming a part of a barrel 22A of a lens unit 5A from a resin material.

The 3D printer 1 forms the barrel 22A by stacking layers of a resin structure using the light-shielding material up to a position higher than a lens 21A. For example, the 3D printer 1 forms an inner step portion 26A in an end face as a surface of the front end of the barrel 22A. The inner step portion 26A is a step formed from the end face to the inner face of the barrel 22A. The inner step portion 26A is formed into, for example, a shape similar to the inner diameter of the barrel 22A.

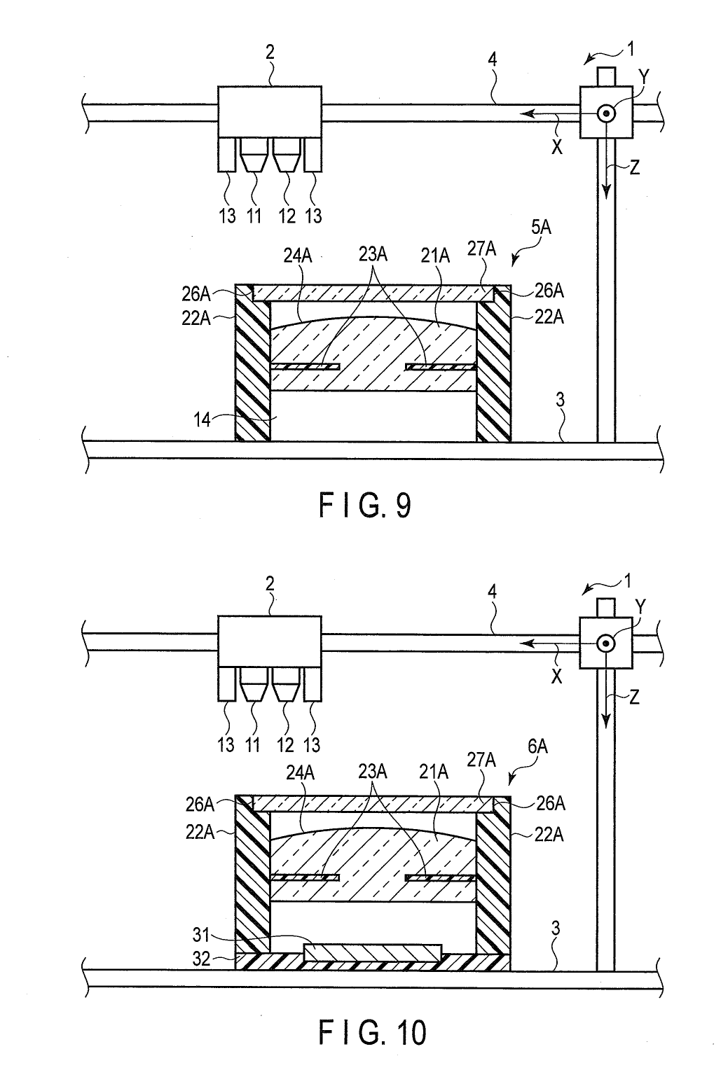

FIG. 9 is an explanatory drawing illustrating an example of a step of forming a cover plate 27A for protection, with which the lens 21A is covered, in the front end of the lens unit 5.

The cover plate 27A in a circular shape, which is made of glass and fits in the shape of the inner step portion 26A, is put on the inner step portion 26A, and is bonded thereto. This enables the cover plate 27A to protect the lens 21A of the lens unit 5. The cover plate 27A may be previously formed from the transmissive material by the 3D printer 1 in a manner to conform to the shape of the inner step portion 26A. In this case, the cover plate 27A is put on the inner step portion 26A, thereby being loaded on the lens unit 5A.

Next, the image sensor 31 is loaded on the lens unit 5A as in FIGS. 6 and 7, so that an imaging apparatus 6A is produced and is arranged on the stage 3 of the 3D printer 1. FIG. 10 shows an example in which the imaging apparatus 6A is arranged on the stage 3 of the 3D printer 1. The 3D printer 1 measures the optical performance of the lens 21A of the lens unit 5A in accordance with an image signal generated by the image sensor 31. For example, in the case where light with a predetermined intensity is caused to enter the lens unit 5A from its front end side, the 3D printer 1 measures the optical performance of the lens 21A of the lens unit 5A in accordance with an image signal generated by the image sensor 31. Specifically, the 3D printer 1 measures, as the optical performance, a decrease in image quality due to factors such as a focal length, a view angle, and various distortions of the lens 21A, in accordance with an image signal.

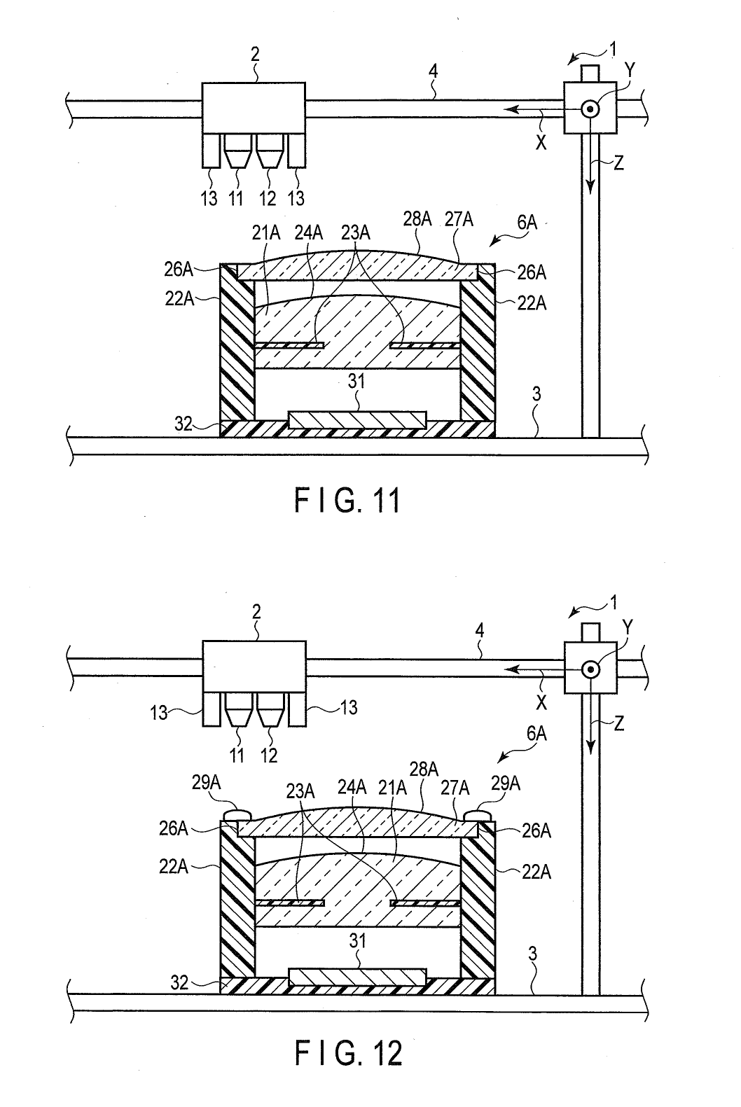

FIG. 11 is an explanatory drawing illustrating an example of a step of forming a compensation optical system 28A on the cover plate 27A of the lens unit 5A. The 3D printer 1 forms the compensation optical system from the transmissive material on the cover plate 27A based on a result of the measurement. The 3D printer 1 includes a memory that stores, for example, a preset condition. The 3D printer 1 determines whether the measurement result of the optical performance of the lens 21A satisfies the condition stored in the memory. In the case of determination that the measurement result fails to satisfy the condition, the 3D printer 1 forms the compensation optical system 28A by stacking on the cover plate 27A the transmissive material in a shape previously stored in accordance with a measurement result. For example, in the case where a measured focal distance is larger than a preset distance, the 3D printer 1 forms a convex lens shape with a large curvature (R), as the compensation optical system 28A, on the cover plate 27A. In the case where a measured focal distance is smaller than a preset distance, the 3D printer 1 forms a concave lens shape with a large curvature (R), as the compensation optical system 28A, on the cover plate 27A. In this manner, the 3D printer 1 compensates the optical characteristics of the lens unit 5A. A resin structure to be formed as the compensation optical system 28A may form an anisotropic three-dimensional shape instead of a simple R-shape.

FIG. 12 is an explanatory drawing illustrating an example of a step of forming a seal 29A on the periphery of the cover plate 27A of the lens unit 5A.

For example, in the case of combining the lens unit 5A with the cover plate 27A that is formed separately, the inner step portion 26A needs to be formed with a dimensional tolerance for the cover plate 27A. This need generates the possibility that a gap is formed between the side face of the inner step portion 26A and the periphery of the cover plate 27A. Therefore, the 3D printer 1 forms the seal 29A by stacking the transmissive material or the light-shielding material between the side face of the inner step portion 26A and the cover plate 27A. The seal 29A formed in this manner improves the airtightness inside the lens unit 5A.

According to the above embodiment, the compensation optical system 28A enables the 3D printer 1 to absorb variation in optical performance of the lens 21A due to assembling errors caused when the substrate 32 on which the image sensor 31 is mounted is loaded on the lens unit 5A.

The 3D printer 1 may be configured in a manner to form an flare aperture 30 by stacking the light-shielding material on the curved surface 24 of the lens 21 of the lens unit 5 described in the above first embodiment, in which the flare aperture 30 limits a region through which light is transmitted on the curved surface 24 of the lens 21.

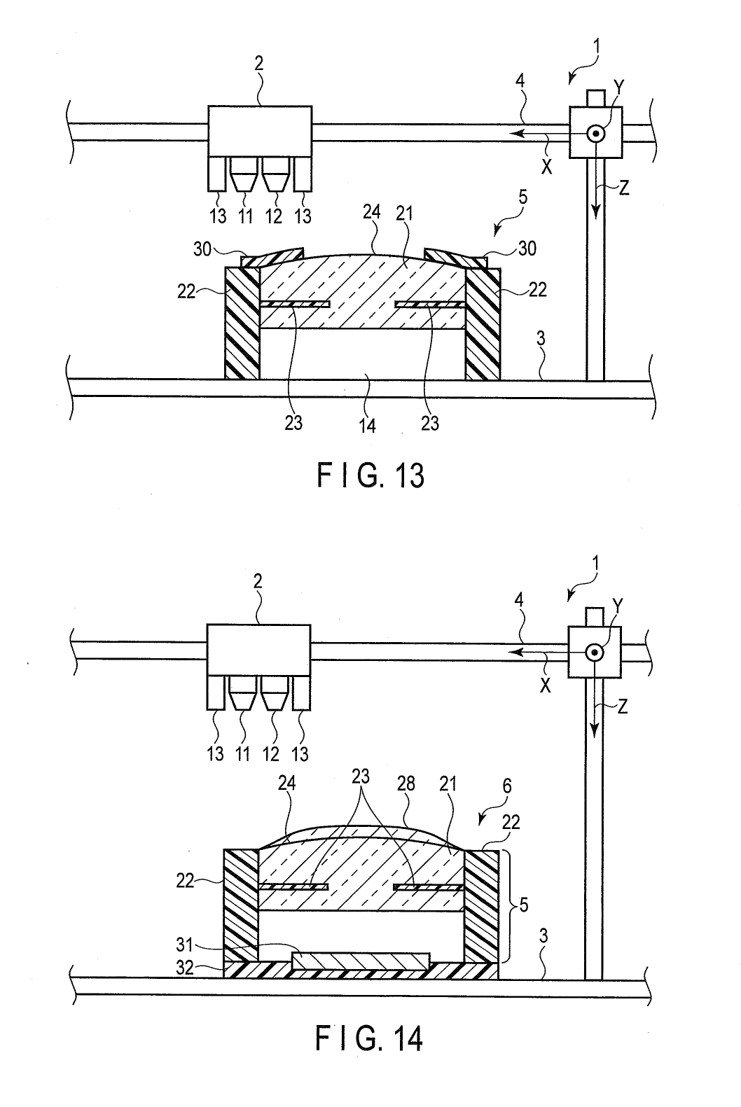

FIG. 13 is an explanatory drawing illustrating an example of a step of forming the flare aperture 30. For example, the 3D printer 1 forms, as the flare aperture 30, a layer of a resin structure made of the light-shielding material, in which an opening is set to an effective region on the curved surface 24 of the lens 21, the effective region depending on the image sensor 31. The flare aperture 30 makes it possible to prevent light unrelated to imaging from entering the barrel 22 of the lens unit 5.

In the above second embodiment, the example in which the compensation optical system 28A is formed on the cover plate 27A was described. However, the second embodiment is not limited to this configuration. The 3D printer 1 may be configured to form the compensation optical system 28 on the curved surface 24 of the lens 21 of the lens unit 5 described in the first embodiment.

FIG. 14 is an explanatory drawing illustrating an example of a step of forming the compensation optical system 28 on the curved surface 24 of the lens 21. In this case, the 3D printer 1 produces the imaging apparatus 6 by combining the lens unit 5 with the image sensor 31, as in the second embodiment. In addition, the 3D printer 1 measures optical characteristics of the lens 21 in accordance with an image signal generated by the image sensor 31, and in accordance with a measurement result, stacks the transmissive material on the curved surface 24 of the lens 21, thereby forming the compensation optical system 28.

Described in the above embodiments is that the lens unit 5 forms an axially symmetrical shape around the optical axis of the lens 21. However, the embodiments are not limited to this configuration. According to existing methods, lenses are formed into a circular shape in order to make it easy to grind and polish glass or resin in the production of lenses. However, in the case of producing lens units by the 3D printer 1, lens units in any shape can be produced through similar steps.

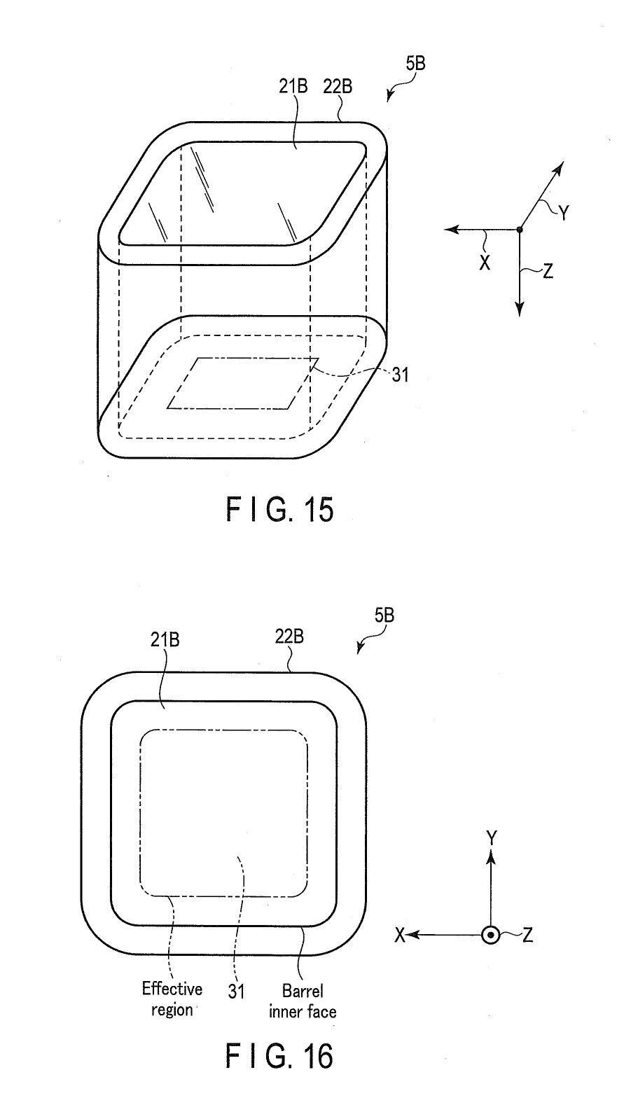

FIGS. 15 and 16 are views each illustrating an example of a lens unit 5B that is produced to have a different shape from those of the lens unit 5 and the lens unit 5A.

A lens 21B of the lens unit 5B includes an effective region within a range covering a region that allows passage of light by which an image is formed on the imaging plane of the image sensor 31 to be loaded. A shape of the effective region depends on a shape of the imaging plane of the image sensor 31, on which an image is to be formed. The effective region is a region on the lens 21B that allows transmission of light which is to enter the imaging plane of the image sensor 31. The lens 21B is merely required to form a shape larger than at least the effective region in consideration of production errors. For example, the 3D printer 1 forms an outline of the lens 21B, into a shape that depends on a shape of the effective region. For example, the 3D printer 1 forms an outline of the lens 21B, into a shape similar to the effective region, as shown in FIGS. 15 and 16. Furthermore, the 3D printer 1 forms an inner shape of the barrel 22B, in a manner to conform to the lens 21B. In the lens 21B according to the configuration described above, a part that allows passage of light not entering the imaging plane is smaller than a normal circular lens which covers an effective area. Therefore, according to this configuration, it is possible to cut light which passes outside the effective region of the lens 21B and enters the barrel 22B, and to inhibit generation of unnecessary light. In addition, the lens unit 5 can be made more compact than a lens unit using a circular lens. Since the lens unit 5 can be made compact, it is possible to reduce resin material required for the production of the lens unit 5.

In the above embodiments, the example in which the lens unit 5 is produced by stacking the resin structures in order from the rear end side was described. However, the embodiments are not limited to this configuration. The direction of stacking resin structures may be any direction.

The present invention is not limited to the above-described embodiments and can be embodied in practice by modifying the structural elements without departing from the gist of the invention. In addition, various inventions can be made by suitably combining the structural elements disclosed in connection with the above embodiments. For example, some of the entire structural elements described in the embodiments may be omitted. In addition, the structural elements between different embodiments may be combined as appropriate.

1. A method of producing a lens unit, the method comprising:
forming a layer by discharging a transmissive material that allows transmission of light and a light-shielding material that shields light in a manner to switch between the transmissive material and the light-shielding material, and by curing the discharged materials by irradiation with light; and
stacking formed layers to form a lens from the transmissive material and form a barrel that holds the lens from the light-shielding material.

2. The method of producing a lens unit according to claim 1, further comprising forming, within the barrel, a circular aperture that limits an amount of light passing through the lens from the light-shielding material.

3. The method of producing a lens unit according to claim 1, further comprising forming a flare aperture that limits a region through which light is transmitted on a surface of the lens from the light-shielding material.

4. The method of producing a lens unit according to claim 1, wherein an outline of the lens is formed into a shape similar to an effective region on a surface of the lens, the effective region depending on a shape of an image sensor on which an image is to be formed.

5. The method of producing a lens unit according to claim 1, further comprising forming a cover plate from the transmissive material, the cover plate that forms a flat-plate shape and covers the lens.

6. A method of producing a lens unit, the method comprising:
stacking layers including at least one of a transmissive part formed by discharging a transmissive material that allows transmission of light and by curing the discharged transmissive material by irradiation with light, and a light-shielding part formed by discharging a light-shielding material that shields light and by curing the discharged transmissive material by irradiation with light;
forming a lens from the transparent part; and
forming a barrel integrally with the lens from the light-shielding material so that the barrel holds the lens.

7. A method of producing an imaging apparatus, the method comprising:
forming a layer by discharging a transmissive material that allows transmission of light and a light-shielding material that shields light in a manner to switch between the transmissive material and the light-shielding material, and by curing the discharged materials by irradiation of light;
stacking formed layers to form a lens from the transmissive material and form a barrel that holds the lens from the light-shielding material; and
arranging an image sensor in a focal position of the lens.

8. The method of producing an imaging apparatus according to claim 7, further comprising:
measuring optical performance of the lens by the image sensor; and
forming a compensation optical system on the lens based on a result of the measuring.

9. The method of producing an imaging apparatus according to claim 7, further comprising forming a cover plate from the transmissive material, the cover plate that forms a flat-plate shape and covers the lens.

10. The method of producing an imaging apparatus according to claim 9, further comprising:
measuring optical performance of the lens by the image sensor; and
forming a compensation optical system on the cover plate based on a result of the measuring.
